(19) United States
(12) Patent Application Publication
(10) Pub. No.: US 2007/0060293 A1
(43) Pub. Date: Mar. 15, 2007

(54) Method, apparatus, and program product for presenting gaming results through numerical symbols

(75) Inventor: Galen Svanas, Austin, TX (US)

Correspondence Address: THE CULBERTSON GROUP, P.C., 1114 LOST CREEK BLVD., SUITE 420, AUSTIN, TX, 78746, US

(73) Assignee: Multimedia Games, Inc.

(21) Appl. No.: 11/269,001

(22) Filed: Nov. 8, 2005

Related U.S. Application Data
(60) Provisional application No. 60/716,098, filed on Sep. 12, 2005.

(51) Int. Cl. A63F 13/00

(52) U.S. Cl. 463/20

(57) ABSTRACT

A method includes displaying a number of symbol locations with one or more paylines defined through the symbol locations. In response to a player input, each of the number of symbol locations conducts a respective symbol change process to change from an initial symbol displayed at the respective symbol location to a respective numerical symbol included in a group of presentation symbols. An award is then presented based at least in part on a numerical characteristic of the numerical symbols aligned along at least one payline. For example, an award may be presented when the numerical symbols aligned along a payline add up to at least some predefined value.

### CROSS-REFERENCE TO RELATED APPLICATION

The Applicant claims the benefit, under 35 U.S.C. §119(e), of U.S. Provisional Patent Application No. 60/716,098 filed Sep. 12, 2005, and entitled “METHOD, APPARATUS, AND PROGRAM PRODUCT FOR PRESENTING GAMING RESULTS THROUGH NUMERICAL SYMBOLS.” The entire content of this provisional application is incorporated herein by this reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all rights of copyright.

### TECHNICAL FIELD OF THE INVENTION

This invention relates to gaming machines and systems. More particularly, the invention relates to methods for presenting gaming results to a player through a graphic display in which the award to the player is based at least in part upon a numerical characteristic of numerical symbols aligned along a payline. The invention also encompasses a gaming apparatus and program product for implementing the presentation method.

### BACKGROUND OF THE INVENTION

A large number of different gaming machines have been developed to provide various formats and graphic presentations for conducting games and presenting game results. For example, numerous mechanical reel-type gaming machines, also known as slot machines, have been developed with different reel configurations, reel symbols, and paylines. More recently, gaming machines have been developed with video monitors that are used to produce simulations of mechanical spinning reels. These video-based gaming machines may use one or more video monitors to provide a wide variety of graphic effects in addition to simulated spinning reels, and may also provide secondary/bonus games using different reel arrangements or entirely different graphics. Video-based gaming machines may also be used to show card games or various types of competitions such as simulated horse races in which wagers may be placed. Game manufacturers are continuously pressed to develop new game presentations, formats, and game graphics in an attempt to provide high entertainment value for players and thereby attract and keep players.

### SUMMARY OF THE INVENTION

The present invention includes a highly entertaining method of presenting gaming results through an array of graphic symbol locations through which one or more paylines are defined. The entertainment value is achieved by basing an award to the player at least in part upon a numerical characteristic of numerical symbols aligned along a payline. Entertainment value is also enhanced in some forms of the invention using a bonus award feature to provide a bonus payout based on the array of graphic symbols and without having to conduct a separate bonus game. The present invention also encompasses both a gaming apparatus and program products for implementing methods according to the invention.

A method embodying principles of the invention may be implemented using one or more display devices such as CRTs, LCDs, plasma displays, or other types of display devices. The display device or devices used to show graphic elements according to the invention will commonly be associated with a gaming machine through which a player may participate in a game. Alternatively, the present invention may be implemented with a gaming machine that includes a mechanical reel arrangement to show the various graphic elements. As used in this disclosure and the accompanying claims, a gaming machine through which the present invention may be implemented will be referred to generally as a player station.

One preferred method according to the invention includes displaying a number of symbol locations with one or more paylines defined through the symbol locations. In response to a player input, each of the number of symbol locations conducts a respective symbol change process to change from an initial symbol displayed at the respective symbol location to a respective numerical symbol included in a group of presentation symbols. An award is then presented based at least in part on a numerical characteristic of the numerical symbols aligned along at least one payline. For example, an award may be presented when the numerical symbols aligned along a payline add up to at least some predefined value. In this example, the numerical characteristic upon which the award is based comprises the sum of the numerical symbols along a payline. One preferred implementation of the invention employs a group of presentation symbols comprising the six different faces of a standard die, so that each numerical symbol has a value between one and six.

One form of the invention also includes presenting a bonus award when the numerical symbols displayed at the number of symbol locations match a predefined numerical symbol configuration. For example, a bonus award may be presented when some predefined number of symbol locations show the same numerical symbol. In this case, the predefined numerical configuration is defined in terms of a number of matching numerical symbols in the display. In order to give a player a sense of how close they came to obtaining a bonus award on a given play in the game, a method according to the invention may include displaying a graphic representation of an analog gauge in which a gauge needle traverses a portion of the gauge proportional to the number of matching numerical symbols displayed at the number of symbol locations.

An apparatus embodying the principles of the present invention includes a display device, a player input device, and a presentation controller, all preferably associated with a player station. The presentation controller causes the display device to display the number of symbol locations defining one or more paylines and receives a first player input entered through the player input device to initiate a game cycle. The presentation controller also causes the display device to display a respective symbol change process for each of the number of symbol locations. At the end of a game cycle, the presentation controller causes the display device to display an award that may be based at least in part on a numerical characteristic, such as a sum for example, of the various numerical symbols aligned along a payline.

The result presented to a player as an award according to the invention may be obtained in any suitable fashion. In some forms of the invention, the apparatus may receive results identified from a separate device or system. Particularly in these forms of the invention, the result may actually be a result from an electronic lottery game, a bingo game, or some other game. In other forms of the invention, a result controller may be included at the player station and adapted to communicate a game play result to the presentation controller in response to a result requesting input entered through the input device. Whether the result is obtained from a separate device or from some component at the player station itself, the presentation controller controls the symbols displayed in the course of a game cycle to be consistent with the obtained result. Regardless of any underlying game from which a result is identified in the present invention, a “play” or “game play” referenced in this disclosure will refer to the game cycle of a graphic presentation according to the invention.

A program product embodying the principles of the invention is stored on one or more computer readable devices and preferably includes initial symbol control program code, player interface program code, symbol change control program code, and award display program code. The initial symbol control program code is executable to cause a display device to display a number of symbol locations defining at least one payline as described above. The player interface program code is executable to receive a player input to initiate a game cycle according to the invention. The symbol change control program code is executable to cause the display device to display the symbol change process at each of the symbol locations. The award display program code is executable to cause the display device to display the award obtained for the game cycle.

These and other advantages and features of the invention will be apparent from the following description of preferred embodiments, considered along with the accompanying drawings.

### BRIEF DESCRIPTION OF THE DRAWINGS

FIG. 1 is a perspective view of a player station that may be used to implement a game presentation according to the invention.

FIG. 2 is a diagrammatic representation of a player station and gaming system that may be used to implement methods according to the present invention.

FIG. 3 is a flow chart showing a method embodying the principles of the present invention.

FIG. 4 is a representation of a graphic display that may be generated to display a gaming result according to the present invention.

FIG. 5 is a representation of a paytable that may be used to correlate arrangements of the numerical symbols with various prizes in the graphic display shown in FIG. 4.

### DESCRIPTION OF PREFERRED EMBODIMENTS

The claims at the end of this document set out novel features which the Applicant believes are characteristic of the invention. The various advantages and features of the invention together with preferred modes of use of the invention will best be understood by reference to the following description of illustrative embodiments read in conjunction with the drawings introduced above.

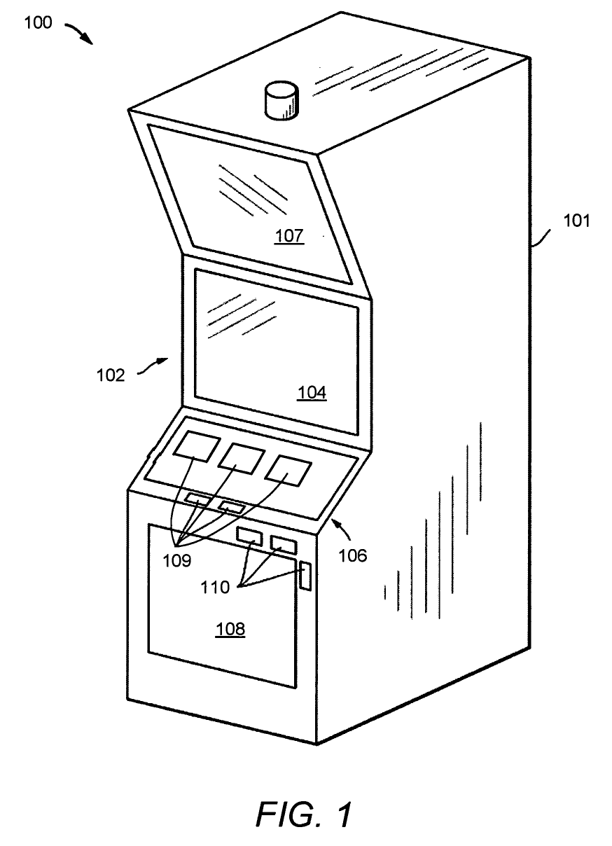

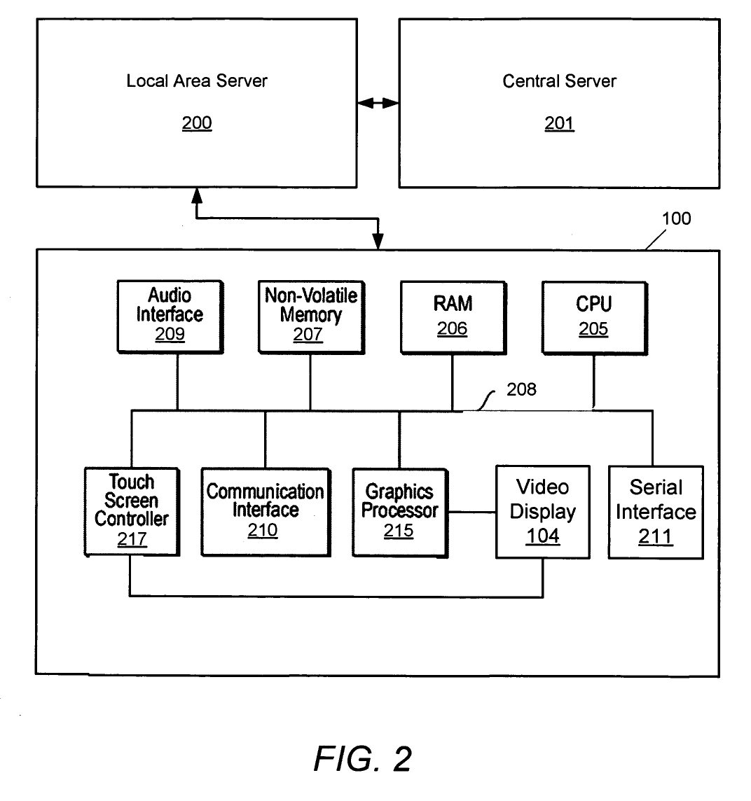

FIG. 1 shows a player station 100 that may be used to implement game presentations according to the present invention. The block diagram of FIG. 2 shows further details of player station 100 connected in a gaming system in which the present invention may be used to present gaming results to players.

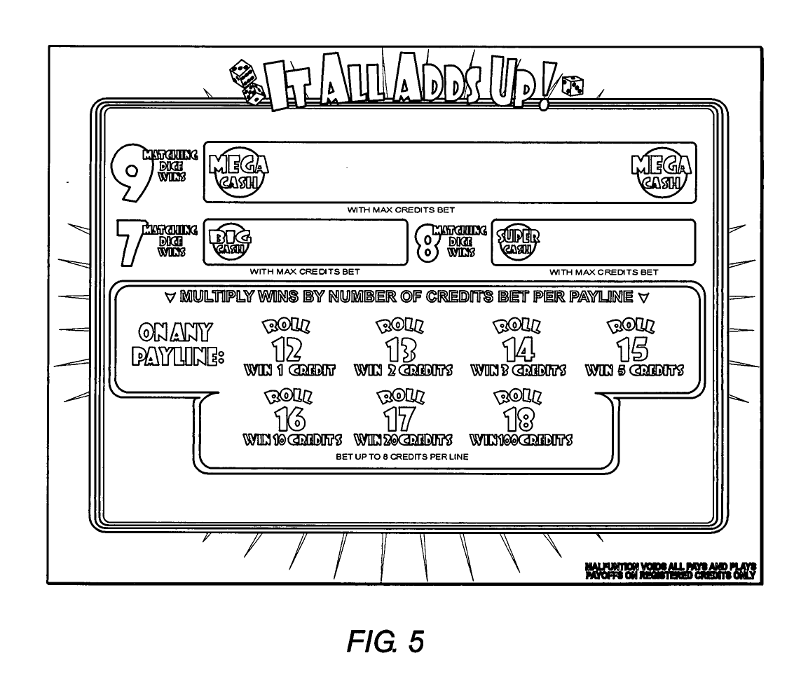

Referring to FIG. 1, a player station 100 includes a cabinet 101 having a front side generally shown at reference numeral 102. A video display device 104 is mounted in a central portion of the front surface 102, with a ledge 106 positioned below the video display device and projecting forwardly from the plane of the video display device. In addition to the video display device 104, the illustrated player station includes a top glass display 107 positioned above the video display device, and a belly glass display 108 positioned below the video display device. In the illustrated player station 100, video display device 104 is used to produce the graphic components making up the game presentation according to the invention. That is, video display device 104 displays the symbol locations and graphic symbols contained in those locations, displays the change processes shown at the symbol locations, and also displays the symbols that correlate to the player's award for a game play. In player station 100, top glass display 107 and bottom glass display 108 contain static graphics related to the particular game presentation. For example, top glass display 107 may show a paytable such as the paytable described below in connection with FIG. 5. Bottom glass display 108 may show additional graphics related to the graphics shown at top glass display 107 and video display device 104.

Player station 100 illustrated in FIG. 1, includes mechanical player control buttons or other input devices 109 mounted on ledge 106. Other forms of the invention may include switches, joysticks, or other player input devices mounted on ledge 106.

It will be appreciated that player stations may also include player interface devices in addition to devices that are considered player controls for use in playing a particular game. Player station 100 also includes additional player interface devices 110 on a lower portion of cabinet 101 generally in the plane of bottom glass display 108. These additional player interface devices 110 may comprise for example, a player card reader, a voucher or ticket reader/issuer, a currency acceptor/validator, and/or a coin or token acceptor/dispenser.

It should be noted that the present invention is by no means limited to implementation with a player station having a single video display such as player station 100 shown in FIG. 1. A game presentation made according to the present invention may be produced with any player station that includes a player interface for enabling a player to make direct inputs, and one or more video display devices, or physical reel arrangements through which the various graphic elements of the game presentation may be produced. Player station 100 is merely shown as an example of a player station through which the invention may be implemented. Other player stations implementing the present invention may include other types of devices that may show game play results. For example, a player station may include a spinning wheel to show results. These other types of result display devices may be used to show some gaming results to the player, while the presentation according to the invention may be used to show other results. It should also be noted that the video display device 104 used in player station 100, or some other player station that may be used to implement the invention, may comprise any suitable video display device including a cathode ray tube, liquid crystal display, plasma display, LED display or any other type of video display currently known or that may be developed in the future.

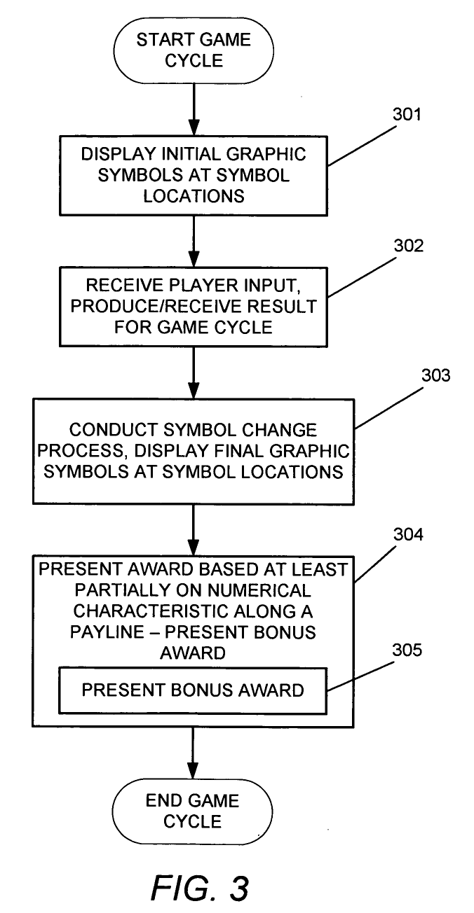

FIG. 2 provides a block diagram showing various components of player station 100 together with gaming system components external to the player station. In particular, FIG. 2 shows player station 100 connected for communication with a local area server 200 and a central server 201. Local area server 200 and central server 201 may be used together with player station 100 and other player stations to implement a bingo gaming system, such as the bingo gaming system described in U.S. patent application publication No. 2004-0152499-A1, or to implement a lottery gaming system such as the lottery gaming system shown in U.S. patent application publication No. 2005-0137010-A1 or U.S. Pat. No. 6,733,385, for example. Regardless of the precise manner in which results are identified in a given system, local area server 200 and central server 201, or both servers, may cooperate to identify results that are provided to player station 100 in response to a result requesting input entered at the player station. That is, local area server 200 and/or central server 201, or more particularly, one or more processing devices associated with server 200 and/or server 201 may serve as a result controller for identifying results used by player station 100 as described further below with reference to FIG. 3. Even in implementations in which results are produced at the player station 100 in some fashion, local area server 200 and/or central server 201 may be used to provide player tracking and accounting services for the player stations included in the gaming system.

The player station 100 shown in FIG. 2 includes a central processing unit (CPU) 205 along with random access memory 206 and nonvolatile memory or storage device 207. All of these devices are connected on a system bus 208 with an audio interface device 209, communications interface 210, and a serial interface 211. A graphics processor 215 is also connected on bus 208 and is connected to drive the video display device 104 (mounted on cabinet 101 as shown in FIG. 1). As shown in FIG. 2, player station 100 also includes a touch screen controller 217 connected to system bus 208. Touch screen controller 217 is also connected to receive signals from a touch screen element associated with video display device 104. It will be appreciated that the touch screen element itself comprises a thin film that is secured over the display surface of video display device 104. The touch screen element itself is not illustrated or referenced separately in the figures.

Those familiar with data processing devices and systems will appreciate that other basic components will be included in player station 100 such as a power supply, cooling systems for the various system components, audio amplifiers and speakers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer. These elements are preferably mounted on a standard personal computer chassis and housed in a standard personal computer housing which is itself mounted in cabinet 101 shown in FIG. 1. Alternatively, the various electronic components may be mounted on one or more circuit boards housed within cabinet 101 without a separate enclosure such as those found in personal computers. Those familiar with data processing systems and the various data processing elements shown in FIG. 2 will appreciate that many variations on this illustrated structure may be used within the scope of the present invention. For example, since serial communications are commonly employed from a touch screen element secured over a video display surface, a system according to the invention may not include a separate touch screen controller 217. Rather, communications from the touch screen elements may be accommodated through any suitable peripheral interface such as a USB controller or a IEEE 1394 controller. Thus, the connection shown from touch screen controller 217 to video display device 104 may alternatively run from the video display device (or more precisely the touch screen element associated with the video display device) to serial interface 211 or any other suitable interface. Numerous other variations in the player station internal structure and system may be used in accordance with the principles of the present invention.

It will also be appreciated that graphics processors are also commonly a part of modern computer systems. Although separate graphics processor 215 is shown for controlling video display device 104, it will be appreciated that CPU 205 may control the video display device directly without any intermediate graphics processor. The invention is not limited to any particular arrangement of graphics processors for controlling the video display device.

In the illustrated player station 100, CPU 205 executes software which ultimately controls the entire player station including the receipt of player inputs and the presentation of the graphic symbols at the various symbol locations displayed according to the invention through the video display device 104 associated with the player station. Thus, CPU 205 either alone or in combination with graphics processor 215 serves as a presentation controller according to the invention. Where the player station itself produces results for a player, CPU 205 also serves as a result controller. CPU 205 also executes software related to communications handled through communications interface 210, and software related to various peripheral devices such as those connected to the system through audio interface 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 provides storage for programs not in use or for other data generated or used in the course of player station operation. Communications interface 210 provides an interface to other components of a gaming system that may be involved in game play, such as local area server 200 and/or central server 201.

It should be noted that the invention is not limited to player stations employing the personal computer-type arrangement of processing devices and interfaces shown in example player station 100. Other player stations may include one or more special purpose processing devices to perform the various processing steps for implementing the present invention. Unlike general purpose processing devices such as CPU 205, these special purpose processing devices may not employ operational program code to direct the various processing steps.

FIG. 3 comprises a process flow chart showing a complete game cycle according to one preferred form of the present invention. As indicated at process block 301, the process begins with displaying the number of symbol locations. After this initial display, a player input is received as indicated at process block 302. In response to the player input, each symbol location is caused to conduct a respective symbol change process as indicated at process block 303. At the conclusion of the step indicated at process block 303, each symbol location shows a respective numerical symbol included in a group of presentation symbols. As indicated at process block 304, the method includes presenting an award based at least in part on a numerical characteristic of the numerical symbols aligned along at least one payline defined through the number of display symbol locations.

The step indicated at process block 301 in FIG. 3 preferably includes displaying the various symbol locations in an initial condition. This initial condition may include a predefined initial graphic or numerical symbol at each symbol location. For example, some forms of the invention display the same graphic symbol at each symbol location in this initial condition. Other forms of the invention may simply show one of the available numerical symbols at each symbol location in the initial condition at the start of a game cycle. In particular, each game cycle may start with the various symbol locations showing the numerical symbols that were displayed at the end of the previous game cycle at the given player station.

The player input received as indicated at process block 302 in FIG. 3 may be received in any suitable manner. In some preferred forms of the invention, once the symbol locations are all shown in the initial position, the player is prompted to push a play button at the player station, or pull a play handle, or actuate some other play initiating control at the player station. The player input may also require some other input, such as a wager selection input. For example, one preferred implementation of the invention may produce the initiating player input (received as shown at 302 in FIG. 3) only after a player selects from among different wager options at the player station and then actuates a “play” control.

A process according to the present invention may also receive or produce a result for the game cycle at the point of the process indicated at process block 302. For example, the player input may prompt the player station to request a result from a result controller at the player station or elsewhere in the gaming system (such as components 200 or 201 in FIG. 2). The result controller then communicates back a result for the game cycle. The result or data included in or correlating to the result may then be used at the player station to control the display produced at the player station. In particular, the player station ultimately displays an arrangement of numerical symbols consistent with the result that has been assigned for the game cycle. It will be appreciated, however, that a result may be received at some point in the process other than the point indicated at process block 302. For example, a result may be acquired each time the initial display is produced as shown at process block 301, or perhaps even before that point. Alternatively, a result for the game cycle may be obtained while the process is conducting the symbol change processes as indicated at process block 303. It should also be noted that the invention is not limited to applications where a result is obtained and the graphics are forced to correspond to that result. Rather, the symbol change processes indicated at process block 303 may be the processes that dictate the result for the game cycle. That is, the process may use some random or pseudo-random process to select the numerical symbols ultimately displayed at the various symbol locations to dictate the result for the game cycle.

There are numerous ways to conduct the symbol change process for each symbol location as indicated at process block 303 in FIG. 3. In one preferred form of the invention, each symbol location correlates to an actual or simulated reel position. In this case, the symbol change process for a respective symbol location may comprise spinning the reel (or simulating a spin) and then stopping the reel or simulated reel to show either the same or a different numerical symbol. It should be appreciated, however, that the invention is not limited to this reel or simulated reel symbol change process. The invention encompasses any process by which an initial graphic symbol shown at a given symbol location may be changed (or caused to appear to change) and result in the same or a different symbol included in the group of presentation symbols used in the game. One preferred form of the invention provides a dice theme in which the group of presentation symbols comprises the six different faces of a die, that is, die faces showing one, two, three, four, five, or six dots. Although the symbol change process in this die face implementation of the invention may be shown using actual or simulated reels at each symbol location, the symbol change process may alternatively include displaying a graphic at a respective symbol location to imitate the appearance of a tumbling die. This tumbling die graphic could be produced using a video display device such as device 104 in FIG. 1.

The process of presenting the award as shown at process block 304 in FIG. 3 preferably includes controlling the display at the player station in some fashion to show a prize that has been won by the player for the respective game cycle. This prize display may include showing a numerical prize value or showing a graphic representation of a prize amount or a tangible prize. Presenting the award to the player may further include crediting an account for the player, issuing a voucher or ticket for the prize amount, or issuing coins, currency, or tokens for the prize amount. In any event, the award is at least partially based on the numerical characteristic of the various numerical symbols that line up along a payline defined through the various symbol locations.

Some preferred forms of the invention also include presenting a bonus award that may be based on some alternate characteristic defined by the numerical symbols displayed at the end of the game cycle. This bonus award may be presented in addition to the award based on a numerical characteristic of symbols aligned along a payline in the game. One preferred form of the invention presents a bonus award when the numerical symbols displayed at the various symbol locations match a predefined numerical symbol configuration. For example, the numerical symbol configuration may be defined in terms of the number of matching numerical symbols displayed at the end of a game cycle. Continuing with this example, a bonus award may be presented when all of the symbol locations show the same numerical symbol upon completion of the symbol change process indicated at process block 303 in FIG. 3. Other forms of the invention may provide multiple different bonus award. For example, a first bonus award may be presented when seven out of nine numerical symbols match after completion of the symbol change process at each symbol location. A second bonus award may be presented when eight out of nine numerical symbols match, and a third bonus award may be presented when all nine numerical symbols match.

The award and any bonus award or awards to be presented as indicated at process block 304 in FIG. 3 may have fixed values or variable values within the scope of the present invention. One preferred implementation uses fixed values for the awards base at least in part on a numerical characteristic associated with numerical symbols aligned along a payline, and uses progressive values for the bonus awards. These progressive values will vary over time based on the wagering activity in the game at a single player station or multiple player stations.

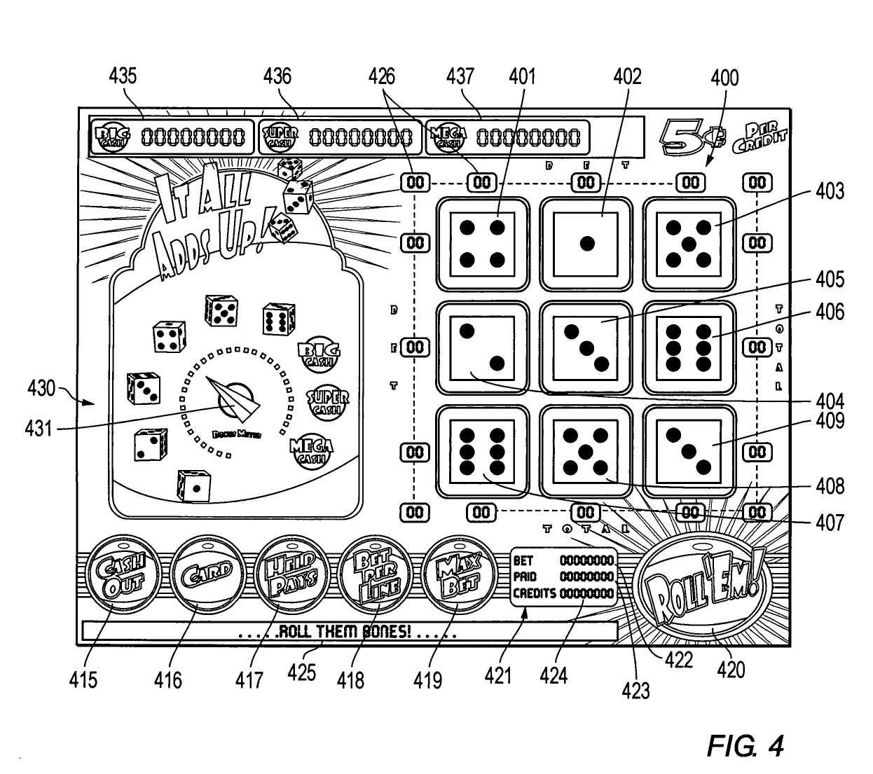

Whether or not a bonus award is presented in a given game cycle, the invention may include displaying a special graphic component dedicated to showing either the bonus award level to be presented or showing how close the player came to obtaining a bonus award for the play. This special graphic display step is shown at process block 305 in FIG. 3. One preferred form of the invention includes displaying a graphic representation of an analog gauge. For each game cycle, the gauge needle is caused to traverse a portion of the gauge corresponding to the degree to which the predefined numerical symbol configuration is matched. An example of this special graphic component will be described below with reference to FIG. 4.

In forms of the invention implemented through general purpose processing devices such as the devices shown in the example player station 100 of FIG. 2, the various steps shown in FIG. 3 are performed under the control of operational program code. One preferred form of the invention executes initial symbol control program code to cause a display device such as video display device 104 in FIGS. 1 and 2 to display the symbol locations in their initial state as indicated at process block 301 in FIG. 3. Player interface program code is executed to receive the player input as shown at process block 302 in FIG. 3. Symbol change program code may be executed to cause the video display device (104 in FIGS. 1 and 2) to show the respective symbol change process at the various symbol locations. The symbol change program code may also be responsible for ensuring that the graphic symbols displayed at the various symbol locations are consistent with a result for the game cycle. Award display program code may be executed to cause the video display device (104 in FIGS. 1 and 2) to display the award. Some forms of the invention may also execute result identifying program code to identify a game play result for the game cycle. This result identifying program code may be executed at the player station or at a processing device remote to the player station such as a processing device included at one of the components 200 and 201 shown in FIG. 2.

FIG. 4 shows a representation of a graphic display (game presentation) that may be produced in a method embodying the principles of the invention. FIG. 5 shows a representation of a paytable that may be employed for the display shown in FIG. 4. The display shown FIG. 4 may be produced on the video display device 104 associated with player station 100 described above and shown in FIGS. 1 and 2. This particular form of the invention includes a dice theme with a symbol field shown generally at 400. Symbol field 400 includes nine separate symbol locations arranged in three rows of three symbol locations each. The top row of symbol locations includes symbol locations 401, 402, and 403, the middle row of symbol locations includes locations 404, 405, and 406, and the bottom row of symbol locations shown in FIG. 4 includes symbol locations 407, 408, and 409. Eight three-symbol paylines are defined through these nine symbol locations. These eight paylines include each horizontal row of symbol locations, each vertical column of symbol locations and both diagonal lines of symbol locations.

In addition to the symbol locations, the display shown in FIG. 4 shows several touchscreen implemented, virtual controls for use by the player in the game. These controls include a cash out button 415, card button 416, help button 417, bet per line button 418, and max bet button 419. A virtual button 420 labeled “Roll 'Em!” serves as a play button in this example display. A status window 421 displays the current bet amount 422, the amount paid for the current play 423, and a player total credit value 424. A message window 425 is also included in the display shown in FIG. 4, in which messages to the player may be displayed. It will be noted that although the example shown in FIG. 4 defines bets and winnings in terms of credits, the invention is by no means limited to this arrangement. In the example shown in FIG. 4, a small window 426 is located at each end of each payline to show the per payline bet that the player has placed for the given game cycle.

The middle and top left portion of the display shown in FIG. 4 is dedicated to graphic components related to bonus awards that may be presented in a game cycle. In particular, FIG. 4 shows an analog gauge representation 430 having an analog needle 431 which may be shown as rotating to point to any one of nine gauge locations, one gauge location for each symbol location included in the display. Each gauge location other than the last three is represented by a die face. The last three gauge locations bear symbols corresponding to the three bonus awards that may be presented according to the invention using the display shown in FIG. 4. The seventh gauge location is labeled “Big Cash,” the eighth gauge location is labeled “Super Cash,” and the ninth gauge location is labeled “Mega Cash.” Bonus award values may be shown in the three windows 435, 436, and 437 running along the top of the display in FIG. 4. It will be noted that all of these values and the values in status window are zeroed out in this example display.

In order to describe one example implementation of the invention, assume that to reach the condition of the display shown in FIG. 4, the initial symbols have been displayed at the various symbol locations as indicated at process block 301 in FIG. 3, that the player has made their input as indicated at process block 302 in FIG. 3, and that each of the symbol locations have gone through the respective symbol change process as indicated at process block 303 in FIG. 3. Thus, the numerical symbols shown in FIG. 4 at the various symbol locations represent the final numerical symbols displayed at the completion of a game cycle. In this example, four paylines meet the predetermined numerical characteristic for an award as defined in the paytable shown in FIG. 5. In particular, the numerical symbols in the bottom row payline made up of symbol locations 407, 408, and 409 total to the value 14, as do the right column payline made up of symbol locations 403, 406, and 409, together with the diagonal payline made up of symbol locations 403, 405, and 407. According to the paytable shown in FIG. 5, each of these paylines entitle the player to an award of three credits per credit that was bet on the respective payline in the game cycle. The numerical symbols aligned along the left vertical payline is made up of locations 401, 404 and 407 total to 12 which entitles the player to a one credit win per credit bet according to the paytable of FIG. 5. Continuing with this example, the resulting arrangement of numerical symbols at the various symbol locations do not entitle the player to any bonus award as defined in the paytable of FIG. 5. That is, the largest number of matching numerical symbols is four. To show this result, gauge needle 431 of analog gauge representation 430 shown in FIG. 4 would start at a position essentially pointing down in this example, and would rev up only to the fourth gauge location showing the four-dot die face. This corresponds to the maximum number of matching numerical symbols achieved in the game play. Had the arrangement of numerical symbols finished the game cycle showing, for example, eight of the same numerical values, gauge needle 431 would have started at the zero location pointing essential down in the example illustration and then “revved up” turning clockwise until it pointed at the eighth gauge location labeled “Super Cash” in FIG. 4. This would indicate that the player would be entitled to the then current value of the “Super Cash” prize shown at the top of the display (window 436) in FIG. 4 and also shown in the paytable of FIG. 5. It will be noted that according to the paytable shown in FIG. 5, the bonus awards are only paid in game cycles where the player has placed the maximum bet to activate each payline.

The example display shown in FIG. 4 and the paytable shown in FIG. 5, are shown only as convenient examples for describing the principles of the invention. Many variations on these basic examples may be employed within the scope of the present invention. In particular, the invention is not limited to any particular manner for displaying the symbol locations, or to any particular numerical symbols. In particular, numerous different types of numerical symbols may be selected for inclusion in a presentation group and the symbols may be animated in some fashion. Furthermore, some forms of the invention may show the symbol locations in some configuration other than a three-by-three grid. It will be appreciated that although the example graphic display shown in FIG. 4 is well suited for implementation in a video format with a player station such as player station 100 shown in FIGS. 1 and 2, this preferred game presentation may be implemented with a mechanical reel gaming machine. Also, numerous variations are possible in the playing rules of the game and the standards for presenting awards for numerical symbols aligned along a payline and for presenting bonus awards.

As used herein, whether in the above description or the following claims, the terms “comprising,” “including,” “carrying,” “having,” “containing,” “involving,” and the like are to be understood to be open-ended, that is, to mean including but not limited to. Only the transitional phrases “consisting of” and “consisting essentially of,” respectively, shall be closed or semi-closed transitional phrases, as set forth, with respect to claims, in the United States Patent Office Manual of Patent Examining Procedures (Eighth Edition, August 2001 as revised May 2004), Section 2111.03.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The above described preferred embodiments are intended to illustrate the principles of the invention, but not to limit the scope of the invention. Various other embodiments and modifications to these preferred embodiments may be made by those skilled in the art without departing from the scope of the present invention.

1. A method including:
(a) displaying a number of symbol locations, the number of symbol locations defining one or more paylines;
(b) in response to a player input, causing each of the number of symbol locations to conduct a respective symbol change process to change from an initial symbol displayed at the respective symbol location to a respective numerical symbol included in a group of presentation symbols; and
(c) presenting an award based at least in part on a numerical characteristic of the numerical symbols aligned along at least one payline.

2. The method of claim 1 wherein the numerical characteristic comprises the sum of the various numerical symbols aligned along the respective payline.

3. The method of claim 1 wherein each numerical symbol comprises the face of a die.

4. The method of claim 1 wherein the symbol change process includes a graphic representation of a tumbling die.

5. The method of claim 1 further including presenting a bonus award when the numeric symbols displayed at the number of symbol locations match a predefined numerical symbol configuration.

6. The method of claim 5 wherein the predefined numerical symbol configuration is defined in terms of the number of matching numerical symbols displayed at the symbol locations.

7. The method of claim 6 further including displaying a graphic representation of an analog gauge in which a gauge needle traverses a portion of the gauge proportional to the number of matching numerical symbols displayed at the number of symbol locations.

8. The method of claim 1 further including receiving a result from a result generating component and controlling the respective symbol change processes so that the respective numeric symbol included at each respective symbol location is consistent with the result.

9. An apparatus including:
(a) a display device;
(b) a player input device; and
(c) a presentation controller, the presentation controller for (i) causing the display device to display a number of symbol locations, the number of symbol locations defining one or more paylines, for (ii) receiving a player input entered through the player input device, for (iii) causing the display device to display each of the number of symbol locations conducting a respective symbol change process to change from an initial symbol displayed at the respective symbol location to a respective numerical symbol included in a group of presentation symbols, and for (iv) causing the display device to display an award based at least in part on a numerical characteristic of the numerical symbols aligned along at least one payline.

10. The apparatus of claim 9 further including a result controller operatively connected for communication with the presentation controller, the result controller communicating a game play result to the presentation controller in response to a result requesting input entered through the player input device.

11. The apparatus of claim 10 wherein the result controller identifies the game play result from an electronic lottery record.

12. The apparatus of claim 10 wherein the display device, player input device, and presentation controller are associated with a player station and the result controller is located remotely from the player station.

13. The apparatus of claim 12 wherein the result controller conducts a bingo game to identify the game play result.

14. The apparatus of claim 9 wherein the display device, player input device, presentation controller, and result controller are included in a player station.

15. A program product stored on one or more computer readable devices, the program product including:
(a) initial symbol control program code executable to cause a display device to display a number of symbol locations, the number of symbol locations defining at least one payline;
(b) player interface program code executable to receive a player input;
(c) symbol change control program code executable to cause the display device to display each of the number of symbol locations conducting a respective symbol change process to change the graphic symbol included at each respective symbol location to a respective numerical symbol included in a group of presentation symbols; and
(d) award display program code executable to cause the display device to display an award based at least in part on a numerical characteristic of the numerical symbols aligned along at least one payline.

16. The program product of claim 15 further including result identifying program code executable to identify a game play result.

17. The program product of claim 16 wherein the result identifying program code is executable to conduct a bingo game to identify the game play result.

18. The program product of claim 16 wherein the result identifying program code is executable to identify the game play result from a respective lottery record selected from a group of electronic lottery records.

19. The program product of claim 16 wherein the result identifying program code is executable to generate the game play result from a result generating algorithm.

20. The program product of claim 15 wherein the symbol change program code is also executable to receive a game play result and control the respective symbol change processes so that the respective graphic symbol included at each respective symbol location is consistent with the game play result.
